(19) United States
(12) Patent Application Publication
(10) Pub. No.: US 2005/0265400 A1
(43) Pub. Date: Dec. 1, 2005

(54) Demultiplexer,display apparatus using the same, and display panel thereof

(76) Inventor: Dong-Yong Shin, Suwon-si (KR)

Correspondence Address: CHRISTIE, PARKER & HALE, LLP, PO BOX 7068, PASADENA, CA, 91109-7068, US

(21) Appl. No.: 11/133,475

(22) Filed: May 17, 2005

(30) Foreign Application Priority Data
May 25, 2004 (KR) 10-2004-0037276

(51) Int. Cl. H04J 3/02

(52) U.S. Cl. 370/540

(57) ABSTRACT

A display device having a display area including a plurality of data lines for applying data signals for displaying an image and a plurality of pixel circuits coupled to the data lines. The display device also includes a plurality of signal lines, a data driver and a demultiplexer. The data driver is coupled to the signal lines, and transmits data currents, each corresponding to at least two of the data signals, to the signal lines. The demultiplexer demultiplexes each of the data currents transmitted over the signal lines and alternately applies the data signals to at least two of the data lines. The demultiplexer applies a first voltage to the data lines to which none of the data signals is applied.

### CROSS REFERENCE TO RELATED APPLICATION

This application claims priority to and the benefit of Korean Patent Application No. 10-2004-0037276, filed on May 25, 2004 in the Korean Intellectual Property Office, the entire content of which is incorporated herein by reference.

### BACKGROUND OF THE INVENTION

1. Field of the Invention

The present invention relates to a demultiplexer and a display apparatus using the same, and a display panel thereof, and more particularly, it relates to a demultiplexer for demultiplexing data currents.

2. Discussion of the Related Art

In general, an organic light emitting diode (also referred to as “OLED,” hereinafter) display device electrically excites phosphorus organic components, and represents an image by voltage-programming or current-programming m×n organic light emitting cells. Each of these organic light emitting cells includes anode, organic thin film, and cathode layers. The organic thin film layer has a multi-layered structure including an emission layer (EML), an electron transport layer (ETL), and a hole transport layer (HTL) to balance electrons and holes and thereby enhance efficiency of light emission. Further, the organic thin film includes an electron injection layer (EIL) and a hole injection layer (HIL).

Methods of driving the organic light emitting cells can include a passive matrix method and an active matrix method. The active matrix method employs a thin film transistor (TFT). In the passive matrix method, an anode and a cathode are formed crossing (or crossing over) each other, and a line is selected to drive the organic light emitting cells. On the other hand, in the active matrix method, a pixel electrode of indium tin oxide (ITO) is coupled to the TFT, and a voltage maintained by the capacitance of a capacitor coupled to a gate of the TFT drives the light emitting cell. The active matrix method can also be classified into a voltage programming method and a current programming method depending on a type of signal transmission to distinctively program the voltage applied to the capacitor.

Such an OLED display device requires a scan driver for driving scan lines and a data driver for driving data lines. The data driver converts digital data signals into analog data signals to apply to all the data lines. Therefore, the number of output terminals should correspond to the number of data lines. However, a typical data driver has only a limited number of output terminals and thus a number of integrated circuits (ICs) are typically used to drive all the data lines.

### SUMMARY OF THE INVENTION

In exemplary embodiments of the present invention, a demultiplexer and a display device using the same to reduce the number of integrated circuits used for a data driver, are provided.

In an exemplary embodiment according to the present invention, a display device including a display area, a plurality of signal lines, a data driver, and a demultiplexer, is provided. The display area includes a plurality of data lines for applying data signals for displaying an image, and a plurality of pixel circuits coupled to the data lines. The plurality of signal lines are coupled to the data driver, and the data driver transmits data currents, each corresponding to at least two of the data signals, to the signal lines. The demultiplexer demultiplexes each of the data currents transmitted over the signal lines and alternately applies the at least two of the data signals to at least two of the data lines. Further, the demultiplexer applies a first voltage to the data lines to which none of the data signals is applied.

In another exemplary embodiment of the present invention, a display panel including a display area, a data driver, and a demultiplexer, is provided. The display area has a plurality of data lines for providing a plurality of data signals, a plurality of scan lines for providing a plurality of selection signals, and a plurality of pixel circuits respectively coupled to the data lines and the scan lines. The data driver generates the data signals to be programmed to the pixel circuits, time-divides the data signals to be applied to at least two of the data lines, and outputs the data signals as a first signal. The demultiplexer demultiplexes the first signal and alternately applies the data signals and a first voltage to the at least two data lines.

In yet another exemplary embodiment according to the present invention, a demultiplexer, including a first switch, a second switch, a third switch, and a fourth switch, is provided. The demultiplexer demultiplexes a time-divided data current inputted from a data driver. The first switch transmits the data current to a first data line in response to a first control signal. The second switch transmits the data current to a second data line in response to a second control signal. The third switch applies a first voltage to the first data line in response to a third control signal. The fourth switch applies the first voltage to the second data line in response to a fourth control signal.

In yet another exemplary embodiment of the present invention, a method for driving a display panel having a plurality of data lines for applying data signals, a plurality of scan lines for applying selection signals, and a plurality of pixel circuits respectively coupled to the data lines and the scan lines, is provided. Selection signals are sequentially applied to the plurality of scan lines in a first field. The data signals and a first voltage are alternately applied to data lines in a first group and data lines in a second group among the plurality of data lines while the selection signals are applied in the first field. The selection signals are sequentially applied to the plurality of scan lines in a second field. The data signals and the first voltage are alternately applied to the data lines in the first group and the data lines in the second group while the selection signals are applied in the second field. The application of the data signals to the data lines in the first field and the application of the data signals to the data lines in the second field have a different application order.

In yet another exemplary embodiment of the present invention, a display device including a plurality of pixel circuits, a plurality of data lines, and a demultiplexer, is provided. The plurality of pixel circuits display an image. The plurality of data lines provide a plurality of data signals corresponding to the image to the pixel circuits. The demultiplexer receives and demultiplexes a plurality of multiplexed data signals to the data signals, and alternately applies the data signals from each multiplexed data signal to at least two data lines. A predetermined voltage is applied to one of the at least two data lines while one of the data signals is applied to another one of the at least two data lines.

### BRIEF DESCRIPTION OF THE DRAWINGS

The accompanying drawings, together with the specification, illustrate exemplary embodiments of the present invention, and together with the description, serve to explain the principles of the present invention, wherein:

FIG. 1 illustrates a display apparatus according to an exemplary embodiment of the present invention;

FIG. 2 is a simplified circuit diagram illustrating a partial internal configuration of a demultiplexer according to an exemplary embodiment of the present invention;

FIG. 3 illustrates a relationship between the demultiplexer and a pixel circuit according to a first exemplary embodiment of the present invention;

FIG. 4 illustrates driving timing diagrams of the demultiplexer in a first field according to a second exemplary embodiment of the present invention;

FIG. 5 shows pixel circuits turned on in the first field;

FIG. 6 illustrates driving timing diagrams of the demultiplexer in a second field according to the second exemplary embodiment of the present invention;

FIG. 7 shows pixel circuits turned on in the second field;

FIG. 8 illustrates parasitic components present in data lines coupled to the demultiplexer according to the second exemplary embodiment of the present invention;

FIG. 9 illustrates an operation of the demultiplexer in a first field according to a third exemplary embodiment of the present invention; and

FIG. 10 illustrates an operation of the demultiplexer in a second field according to the third exemplary embodiment of the present invention.

### DETAILED DESCRIPTION

In the following detailed description, exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive.

There may be parts shown in the drawings, or parts not shown in the drawings, that are not discussed in the specification as they are not essential to a complete understanding of the invention. Like reference numerals designate like elements. Phrases such as “coupling one thing to another” can refer to either “directly coupling a first one to a second one” or “coupling the first one to the second one with a third one provided therebetween”.

Hereinafter, exemplary embodiments of the present invention will be described in detail with reference to the drawings.

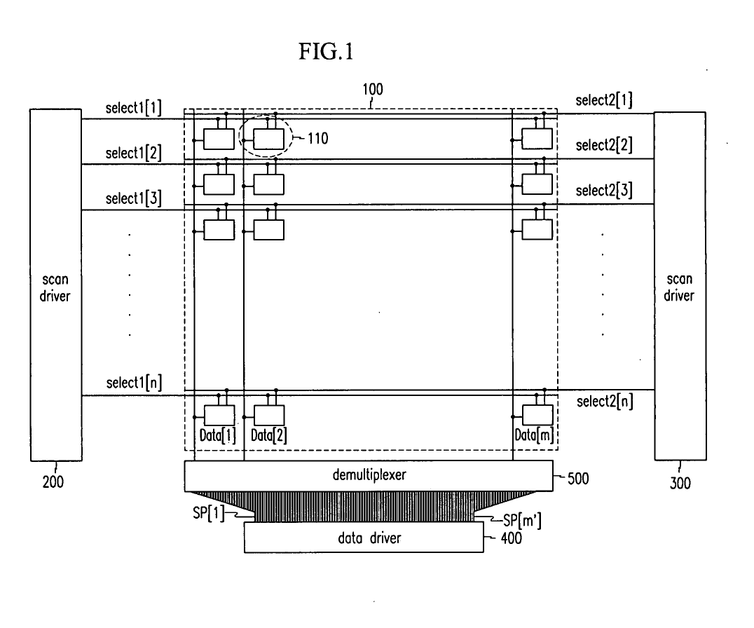

FIG. 1 shows a display device according to an exemplary embodiment of the present invention.

As shown in FIG. 1, a display device according to the exemplary embodiment of the present invention includes a display panel 100, scan drivers 200 and 300, a data driver 400, and a demultiplexer 500.

The display panel 100 includes a plurality of data lines Data[1] to Data[m], a plurality of selection scan lines select1[1] to select1[n], a plurality of emission scan lines select2[1] to select2[n], and a plurality of pixel circuits 110. The plurality of data lines Data[1] to Data[m] are arranged as columns, and transmit data currents for displaying an image to the pixel circuits 110. The plurality of selection scan lines select1[1] to select1[n] and the plurality of emission scan lines select2[1] to select2[n] are arranged as rows, and respectively transmit selection signals and emission signals to the pixel circuits 110. Each pixel circuit 110 is formed in an area where the data line, the emission scan line, and the selection scan line are adjacent to each other.

The scan driver 200 sequentially applies the selection signals to the selection scan lines select1[1] to select1[n], and the scan driver 300 sequentially applies the emission signals to the emission scan lines select2[1] to select2[n]. The data driver 400 outputs the data currents to the demultiplexer 500 through signal lines SP[1] to SP[m′], and the demultiplexer demultiplexes the data currents inputted through the signal lines SP[1] to SP[m′] and transmits the demultiplexed data currents to the data lines Data[1] to Data[m].

According to the exemplary embodiment of the present invention, the demultiplexer is a 1:2 demultiplexer that demultiplexes and provides each data signal (e.g., a data current) inputted from the data driver 400 in a time-divided or multiplexed manner to two data lines. In other words, data signals for the two data lines are time-divisionally multiplexed in a single data signal inputted from the data driver 400. A 1:N demultiplexer (i.e., 1:3 or 1:4) can be employed according to other embodiments of the present invention. While N should generally be an integer less than or equal to 3, N may be larger than 3 in some embodiments.

The scan drivers 200 and 300, the data driver 400, and/or the demultiplexer 500 can be coupled to the display panel 100, or provided as a chip that can be installed to a tape carrier package (TCP) or a flexible printed circuit (FPC) attached to the display panel. Alternatively, the scan drivers 200 and 300, the data driver 400, and/or the demultiplexer 500 can be directly attached to a glass substrate of the display panel 100, and they may be replaced with a driving circuit formed on a glass substrate, wherein the driving circuit is layered in a like manner as how the scan lines, the data lines, and the TFTs are layered.

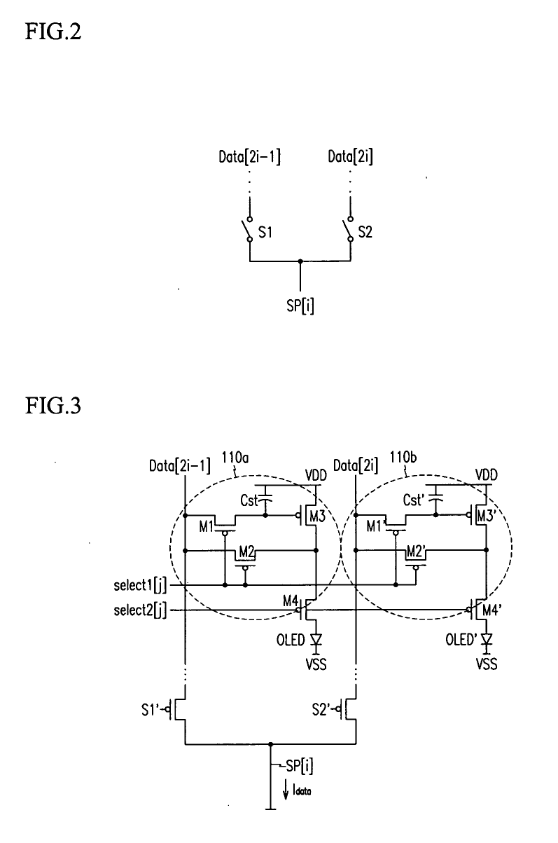

Hereinafter, a demultiplexer 500 according to an exemplary embodiment of the present invention will be described with reference to FIGS. 1 and 2. FIG. 2 illustrates a part of the demultiplexer 500, and may be referred to as a demultiplexer unit. In practice, the demultiplexer 500 would include a plurality of demultiplexer units (e.g., m′ demultiplexer units) that are arranged in parallel to time-divisionally demultiplex the data signals (e.g., data currents) received over the signal lines SP[1] to SP[m′].

As can be seen from FIGS. 1 and 2, the demultiplexer 500 is coupled to the data driver 400 through the signal lines SP[1] to SP[m′], and transmits a data signal (e.g., a data current) transmitted from one signal line SP[i] in a time-divided or multiplexed manner, to two data lines Data[2i−1] and Data[2i]. Two switches S1 and S2 are coupled to one signal line SP[i], and these switches S1 and S2 are respectively coupled to the data lines Data[2i−1] and Data[2i] to demultiplex the data currents that are provided as a multiplexed data current in one signal line SP[i].

The switches S1 and S2 are alternately turned off and on in response to a control signal, and transmit the data signal from the signal line SP[i] to the data lines Data[2i−1] and Data[2i], respectively. The switches S1 and S2 can be replaced with n-MOS transistors, p-MOS transistors, or any other suitable transistors or switches known to those skilled in the art.

Hereinafter, an operation of the demultiplexer according to a first exemplary embodiment of the present invention will be described, referring to FIG. 3.

FIG. 3 illustrates a relationship between the demultiplexer and a pixel circuit according to the first exemplary embodiment of the present invention. FIG. 3 mainly illustrates pixel circuits 110a and 110b coupled to data lines Data[2i−1] and Data[2i] and scan lines select1[j] and select2[j]. By way of example, the pixel circuits 110a and 110b of FIG. 3 may be any two adjacent pixel circuits 110 of FIG. 1 that are respectively coupled to an odd data line Data[2i−1] and an even data line Data[2i] of the m data lines Data[1] to Data[m].

The pixel circuit 110a includes transistors M1, M2, M3 and M4, a capacitor Cst, and an OLED display element or organic light emitting diode (OLED), and the pixel circuit 110b includes transistors M1′, M2′, M3′ and M4′, capacitor Cst′, and an OLED display element (OLED′).

When the selection signal from the scan line select1[j] becomes low, the transistors M1, M2, M1′, and M2′ are turned on. At this time, the data signal is applied to the pixel circuit 110a through the data line Data[2i−1] when a switch S1′ is turned on. Thus, the transistor M3 is diode-connected by the transistors M1 and M2 and a voltage corresponding to the data signal (e.g., data current) from the data line Data[2i−1] is applied to the capacitor Cst.

When a switch S2′ is turned on, the data signal from the signal line SP[i] is applied to the pixel circuit 110b through the data line Data[2i]. Further, the transistor M3′ is diode-connected by the transistors M1′ and M2′ and a voltage corresponding to the data signal (e.g., data current) from the data line Data[2i] is applied to the capacitor Cst′. At this time, the switch S1′ is turned off, and accordingly no current or a current of 0 A is transmitted through the data line Data[2i−1] and a voltage (blank signal) corresponding to the current of 0 A is applied to the capacitor Cst.

Hence, no current or the current of 0 A flows to the OLED in the pixel circuit 110a when an emission signal from the scan line select2[j] turns on the transistors M4 and M4′ to emit light from the pixel circuits 110a and 110b. In other words, the pixel circuit 110a cannot display an expected gray scale and becomes a blank state.

Using separate scan lines for the circuits 110a and 110b may prevent the foregoing problem, but, at the same time, increases the number of lines, thereby decreasing an aperture ratio. Further, additional scan drivers are required to control these separate scan lines, thereby causing manufacturing expenses to be increased.

To alleviate the foregoing problem, the demultiplexer according to a second exemplary embodiment divides one frame into a plurality of fields, and alternately applies a data current to two adjacent pixel circuits.

The following description will be focused on a case in which one frame is divided into a first field and a second field, and a data current is alternately applied to the first pixel circuit and the second pixel circuit. However, one frame may be divided into more than three fields and the length of each field may be varied in other embodiments of the present invention.

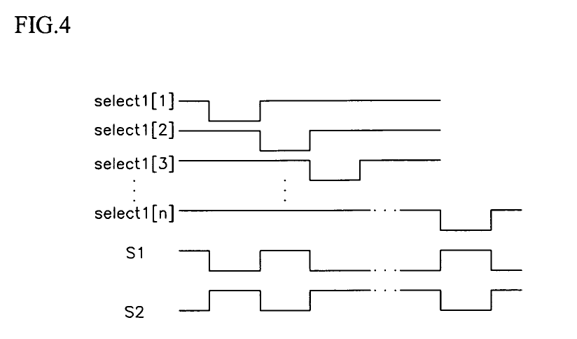

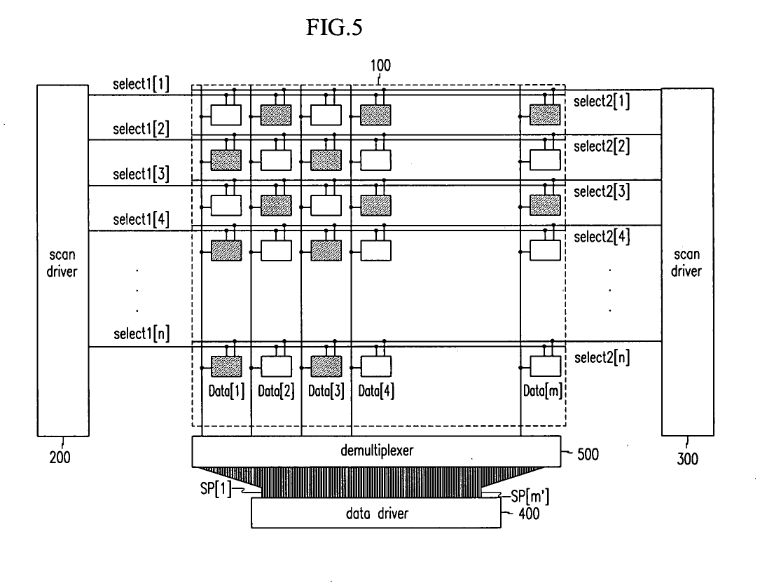

Hereinafter, an operation of the demultiplexer according to the second exemplary embodiment of the present invention will be described with reference to FIGS. 4 to 7.

FIG. 4 illustrates driving timing diagrams of the demultiplexer in the first field, and FIG. 5 illustrates pixels that are turned on in the first field. The pixels that are turned on in the first field are the ones that are not shown as grayed or blacked out in FIG. 5.

In the first field, the switches S1 and S2 are alternately turned on and off while the selection signal is applied to the scan lines select1[1] to select1[n], as shown in FIG. 4.

In more detail, the switch S1 is turned on and the switch S2 is turned off when the selection signal is applied to the scan line select1[1]. In this case, the data signal is applied to the data line Data[2i−1] only and the data signal applied to the data line Data[2i] is cut off. Accordingly, when the emission signal is applied to the scan line select2[1], the pixel circuit 110a coupled to the scan line select1[1] and the data line Data[2i−1] emits light, whereas the pixel circuit 110b coupled to the scan line select1[1] and the data line Data[2i] becomes in the blank state and thus no light is emitted therefrom.

Thus, the emission signal should, but not necessarily, be applied to the scan line select2[1] after an enable period of the selection signal applied to the scan line select1[1] has ended. Further, the pixel circuit can be set to emit light right after the end of the enable period of the selection signal by removing the scan lines select2[1] to select2[n] transmitting the emission signals and changing the transistors M4 and M4′ in FIG. 3 to n-MOS transistors, and then coupling gates of the transistors M4 and M4′ to the scan lines select1[1] to select1[n].

When the selection signal is applied to the scan line select1[2], the switch S2 is turned on and the switch S1 is turned off. Accordingly, the data signal is applied to the data line Data[2i] only and the data signal applied to the data line Data[2i−1] is cut off. In other words, when the emission signal is applied to the scan line select2[2], a pixel circuit (e.g., pixel circuit coupled to the scan line select1[2] and the data line Data[2] of FIG. 5) coupled to the scan line select1[2] and the data line Data[2i] emits light, whereas a pixel circuit (e.g., pixel circuit coupled to the scan line select1[2] and the data line Data[1] of FIG. 5) coupled to the scan line select1[2] and the data line Data[2i−1] becomes the blank state and unable to emit light.

In a like manner, the data signals are sequentially applied to the data line Data[2i−1] and the data line Data[2] by alternately turning on and off the switches S1 and S2 while the selection signal is applied to the scan lines select1[3] to select1[n]. Consequently, the data signals are applied to the pixel circuits coupled to the odd numbered scan line select1[2j−1] and the odd numbered data line Data[2i−1], and then applied to the pixel circuits coupled to the even numbered scan line select1[2j] and the even numbered data line Data[2j], as shown in FIG. 5. Further, the pixel circuit to which the data signal is applied emits light until it becomes the blank state, that is, a half period of one frame. However, the light emission period of the pixel circuit may be extended or shortened by adjusting timing of the emission signal.

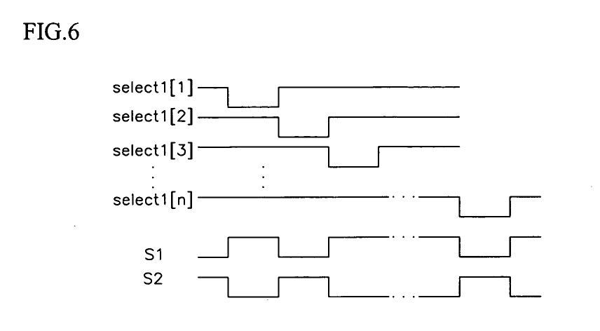

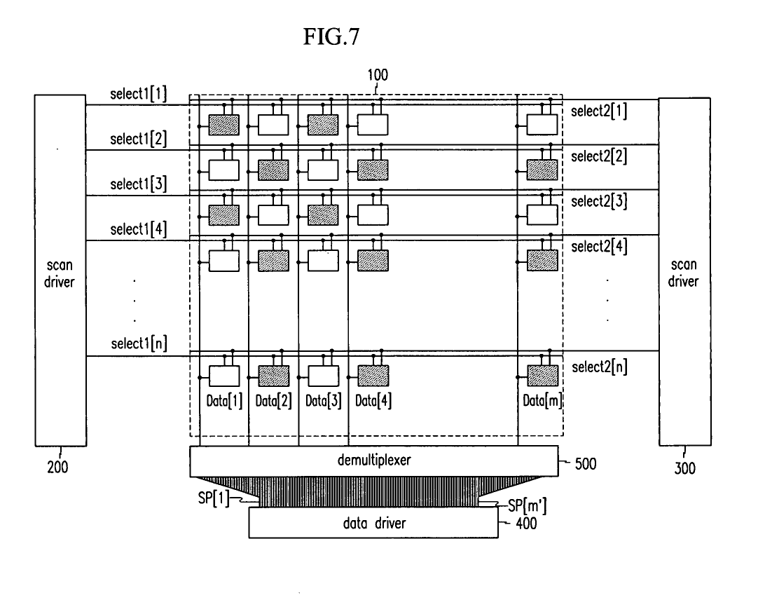

Hereinafter, an operation of the demultiplexer in the second field will be described in reference to FIG. 6 and FIG. 7. FIG. 6 shows driving timing diagrams of the demultiplexer in the second field, and FIG. 7 shows pixels turned on in the second field. The pixels that are turned on in the second field are the ones that are not shown as grayed or blacked out in FIG. 7.

In the second field, the switches S1 and S2 are turned off and on so as to alternately apply the data signals to two adjacent data lines Data[2i] and Data[2i−1] while the selection signal is applied to the scan lines select1[1] to select1[m], as shown in FIG. 6.

It can be seen from FIGS. 5 and 7 that the pixel circuits turned on in the first field are not turned on in the second field, and the pixel circuits not turned on in the first field are turned on in the second field. This is achieved in the second field by turning on the switch S1 and turning off the switch S2 when the select signal is applied to the even scan lines select1[2i] and turning off the switch S1 and turning on the switch S2 when the select signal is applied to the odd scan lines select1[2i−1].

As described, the second exemplary embodiment of the present invention employs a duty driving method which allows light emission during a half period (i.e., one of two fields) of a single frame, and thus the size of data current can be doubled compared to that of a conventional driving method. Therefore, shortage of data programming time due to the use of a demultiplexer can also be solved by doubling the size of the data current.

However, as a result of using the demultiplexer according to the second exemplary embodiment of the present invention, some pixel circuits may be able to emit light although the data signal is not programmed thereto due to parasitic components (e.g., parasitic capacitances) present in the data lines. This problem occurs because capacitors in the pixel circuits are not fully discharged when parasitic components present in the data lines are large.

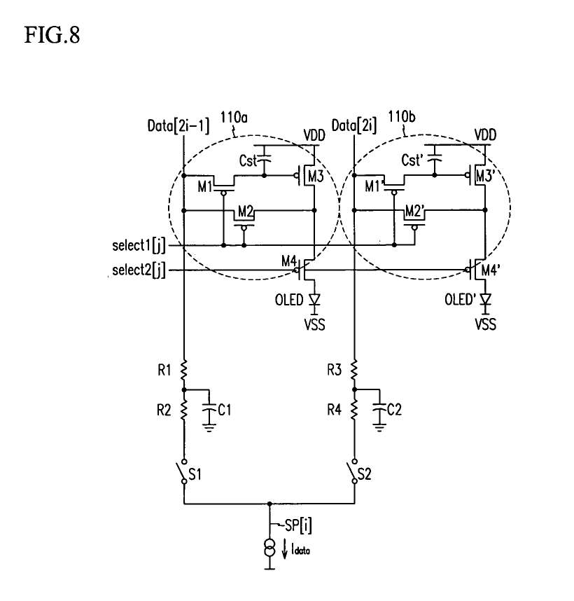

In FIG. 8, the parasitic components present in the data lines, for example, are represented by equivalent parasitic resistors R1 to R4 and equivalent parasitic capacitances C1 and C2.

As shown therein, when the parasitic capacitances C1 and C2 are present in the data lines Data[2i−1] and Data[2i], the capacitors Cst and Cst′ and the parasitic capacitors C1 and C2 are coupled to each other by the transistors M1 and M2 of the pixel circuit 110a and the transistors M1′ and M2′ of the pixel circuit 110b when the selection signal is applied to the selection scan line select1[j].

Therefore, a voltage corresponding to the data current is stored in the capacitors Cst and Cst′ of the pixel circuits 110a and 110b, and the size of voltage in the parasitic capacitors C1 and C2 present in the data lines Data[2i] and Data[2i−1] are changed depending on the data current when the data current is demultiplexed and programmed to the data lines Data[2i] and Data[2i−1].

Here, changing the size of the voltage at the parasitic capacitances C1 and C2 takes longer as the data current becomes smaller, and accordingly much time is consumed for storing the voltage corresponding to the data current in the capacitors Cst and Cst′ of the pixel circuits 110a and 110b or discharging the capacitors Cst and Cst′.

Consequently, the capacitors Cst and Cst′, respectively, are not fully discharged when no current or the current of 0 A is applied by the data driver 400 to the pixel circuits 110a and 110b, respectively, or when the switches S1 and S2 are turned off, respectively, while the selection signal is applied to the selection scan line select1[j]. Moreover, when the emission signal is applied to the emission scan line select2[j], the OLED display element (OLED or OLED′) emits light due to the voltage at the capacitor Cst or Cst′. Such emission of light by a pixel circuit 110a or 110b caused by the parasitic capacitance when it is not programmed during the current field is undesirable.

To solve the foregoing problem, the demultiplexer according to a third exemplary embodiment of the present invention applies a separate blank voltage to one of the data lines coupled to the demultiplexer so as to change the voltage at the parasitic capacitances, while the data current is programmed to the other one of the data lines.

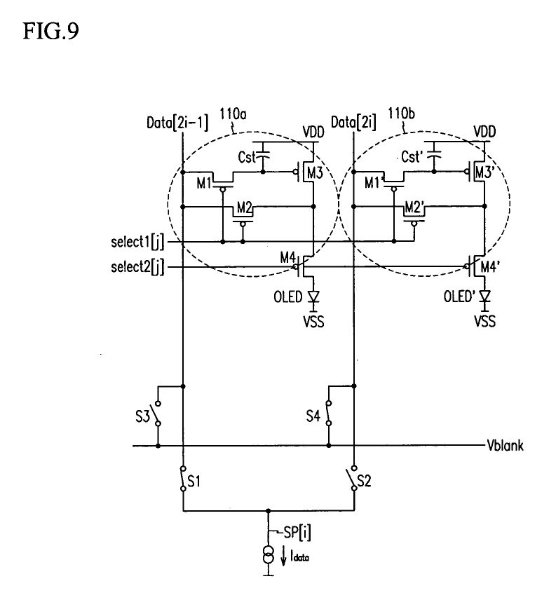

FIG. 9 illustrates a relationship between the demultiplexer and the pixel circuits according to the third exemplary embodiment of the present invention.

As shown therein, the demultiplexer according to the third exemplary embodiment of the present invention further includes switches S3 and S4, which respectively apply the blank voltage to the data lines Data[2i−1] and Data[2i] in response to a control voltage applied thereto, unlike the first and second exemplary embodiments of the present invention.

Further, the switch S3 and the switch S2 are concurrently turned on/off, and the switch S4 and the switch S1 are concurrently turned on/off.

By alternately applying the data current and the blank voltage to the data lines Data[2i−1] and Data[2i] as described above, an influence of the parasitic capacitances C1 and C2 on the pixel circuits is reduced or prevented.

The blank voltage has a voltage range set to express a black level in the pixel circuits, and any suitable predetermined voltage or a voltage that is the same as the power voltage VDD, for example, may be used as the blank voltage in this and/or other embodiments of the present invention.

As described in the second exemplary embodiment of the present invention, the demultiplexer according to the third exemplary embodiment of the present invention may also program the data current to the data lines Data[2i−1] and Data[2i] so as to control the pixel circuits to emit light alternately in the first field and the second field.

In other words, as shown in FIG. 9, the switches S1 and S4 are turned on and the switches S2 and S3 are turned off while the selection signal is applied to the scan line select1[j] in the first field. Then, the data current is programmed to the data line Data[2i−1] and the blank voltage Vblank is applied to the data line Data[2i].

Then, the pixel circuit 110a is turned on and the pixel circuit 110b is turned off when the emission signal is applied to the scan line select2[j].

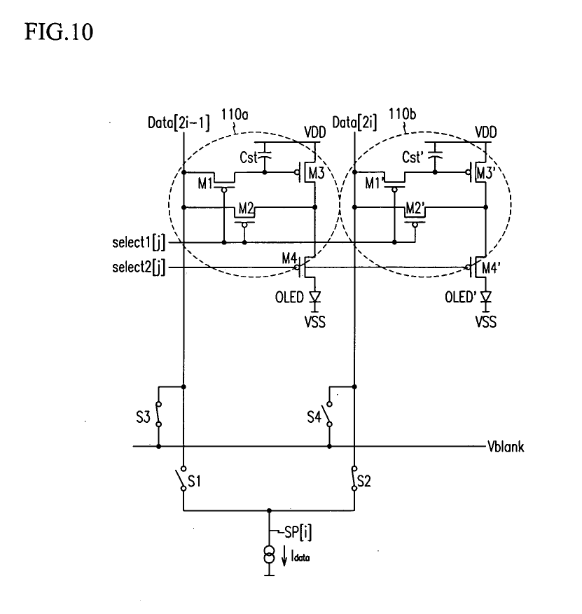

In the second field, as shown in FIG. 10, the switches S2 and S3 are turned on and the switches S1 and S4 are turned off when the selection signal is applied to the scan line select1[j]. Then, the blank voltage Vblank is applied to the data line Data[2i−1] and the data current is programmed to the data line Data[2i].

When the emission signal is applied to the scan line select2[j], the pixel circuit 110b is turned on and the pixel circuit 110a is turned off.

By using the duty driving method turning on the pixel circuits 110a and 110b alternately in the first field and the second field, both of the pixel circuits 110a and 110b can express gray scales corresponding to the respective data signals.

In addition, when a certain pixel circuit, for example the pixel circuit 110a, is set to express the black level, the pixel circuit 110a is coupled to the data driver 400 through the switch S1 in the first field and coupled to the blank voltage Vblank through the switch S3 in the second field.

Thus, the pixel circuit 110a is able to emit light due to the voltage stored in the parasitic capacitances present in the data line Data[2i−1] in the first field when the pixel circuit 110a is coupled to the current source of 0 A (i.e., no current), but the pixel circuit 110a cannot emit light in the second field to which the blank voltage Vblank is applied. Since the first field and the second field are repeated the same number of times, the average brightness of the black level expressed by the pixel circuit 110a is decreased.

In addition, the voltage at the parasitic capacitances is changed into the blank voltage Vblank because the blank voltage is applied to the data line Data[2i−1] while the selection signal is applied to the scan line select1[j−1] in the first field, and therefore the capacitor in the pixel circuit 110a can be fully discharged and turned off in the first field while the selection signal is applied to the scan line select[j].

Further, the OLEDs OLED and OLED′ in the pixel circuits 110a and 110b emit light due to a current respectively provided from the driving transistors M3 and M3′, but the current flowing to the driving transistors M3 and M3′ is influenced by the data current applied to the data lines Data[2i−1] and Data[2i] while the selection signal is applied to the preceding scan line select1[j−1]. In other words, the voltage stored in the parasitic capacitances is changed according to the data current programmed to the data lines Data[2i−1] and Data[2i] while the selection signal is applied to the scan line select1[j−1], and variance of the voltage at the parasitic capacitances affects the voltage charged to the capacitors Cst and Cst′.

Thus, when the blank voltage Vblank is applied to the data lines before the data voltage is applied thereto as described in the third exemplary embodiment of the present invention, the data lines are initialized and the current flowing to the OLED can remain without being influenced by the data current programmed to the pixel circuit of the preceding scan line.

Accordingly, the present invention provides a demultiplexer and a display device using the same that are capable of reducing the number of integrated circuits in the data driver.

In addition, flickering on a display panel can be reduced or eliminated by employing a duty driving method to drive the pixel circuits, and dividing one frame into a plurality of fields and alternately turning on each pixel thereof.

Further, contrast of the display device can be enhanced by decreasing the brightness of a black level.

While the present invention has been particularly shown and described with reference to certain exemplary embodiments thereof, it will be understood by those skilled in the art that various changes in form and details may be made therein without departing from the spirit or scope of the present invention as defined in the appended claims. Therefore, the scope of the invention should be defined by the appended claims, and equivalents thereof.

1. A display device comprising:
a display area comprising a plurality of data lines for applying data signals for displaying an image, and a plurality of pixel circuits coupled to the data lines;
a plurality of signal lines;
a data driver coupled to the signal lines the data driver for transmitting data currents, each corresponding to at least two of the data signals, to the signal lines; and
a demultiplexer for demultiplexing each of the data currents transmitted over the signal lines and alternately applying the at least two of the data signals to at least two of the data lines, and for applying a first voltage to the data lines to which none of the data signals is applied.

2. The display device according to claim 1, wherein the data driver time divides each of the data currents, and applies them to the signal lines.

3. The display device according to claim 1, wherein the demultiplexer comprises at least two first switches respectively having first electrodes coupled to a same one of the signal lines and second electrodes coupled to the at least two data lines, and at least two second switches respectively having first electrodes applied with the first voltage and second electrodes respectively coupled to the at least two data lines.

4. The display device according to claim 3, wherein the at least two first switches respectively coupled to the at least two data lines are alternately turned on, and one of the at least two first switches and one of the at least two second switches that are coupled to a same one of the data lines are turned on by different control signals that are inverted with respect to each other.

5. The display device according to claim 1, wherein the first voltage has a voltage level for displaying black color by the pixel circuits.

6. The display device according to claim 1, wherein at least one of the pixel circuits comprises:
a light emitting device for displaying an image corresponding to a current applied to the at least one of the pixel circuits;
a transistor coupled between a first power source and the light emitting device, wherein the transistor is for controlling the current flowing to the light emitting device corresponding to one of the data signals; and
a capacitor for maintaining a voltage between a gate and a source of the transistor for a predetermined period of time.

7. The display device according to claim 6, wherein the first voltage has a voltage level which is substantially the same as a voltage level supplied from the first power source.

8. The display device according to claim 1, wherein the data signals are applied to the at least two data lines in an order, and wherein the order is changed at least once within one frame.

9. A display panel comprising:
a display area having a plurality of data lines for providing a plurality of data signals; a plurality of scan lines for providing a plurality of selection signals; and a plurality of pixel circuits respectively coupled to the data lines and the scan lines;
a data driver for generating the data signals to be programmed to the pixel circuits, for time-dividing the data signals to be applied to at least two of the data lines, and for outputting the data signals as a first signal; and
a demultiplexer for demultiplexing the first signal and alternately applying the data signals and a first voltage to the at least two data lines.

10. The display panel according to claim 9, wherein the first voltage has a voltage level for expressing black color by the pixel circuits.

11. The display panel according to claim 9, wherein at least one of the pixel circuits comprises:
a light emitting device for displaying an image corresponding to a current applied thereto;
a transistor coupled between a first power source and the light emitting device, wherein the transistor is for controlling the current flowing to the light emitting device corresponding to one of the data signals; and
a capacitor for maintaining a voltage between a gate and a source of the transistor for a predetermined period of time.

12. The display panel according to claim 11, wherein the first voltage has a voltage level which is substantially the same as a voltage level of the first power source.

13. A demultiplexer for demultiplexing a time-divided data current inputted from a data driver, the demultiplexer comprising:
a first switch for transmitting the data current to a first data line in response to a first control signal;
a second switch for transmitting the data current to a second data line in response to a second control signal;
a third switch for applying a first voltage to the first data line in response to a third control signal; and
a fourth switch for applying the first voltage to the second data line in response to a fourth control signal.

14. The demultiplexer according to claim 13, wherein the first control signal and the fourth control signal are substantially the same.

15. The demultiplexer according to claim 14, wherein the second control signal and the third control signal are substantially the same.

16. The demultiplexer according to claim 15, wherein the first control signal and the second control signal are inverted with respected to each other.

17. A method for driving a display panel comprising a plurality of data lines for applying data signals, a plurality of scan lines for applying selection signals, and a plurality of pixel circuits respectively coupled to the data lines and the scan lines, the method comprising:
a) sequentially applying the selection signals to the plurality of scan lines in a first field;
b) alternately applying the data signals and a first voltage to data lines in a first group and data lines in a second group among the plurality of data lines during a);
c) sequentially applying the selection signals to the plurality of scan lines in a second field; and
d) alternately applying the data signals and the first voltage to the data lines in the first group and the data lines in the second group during c),
wherein the b) and d) have a different application order for the data signals.

18. The method according to claim 17, wherein the data lines in the first group are odd-numbered data lines and the data lines in the second group are even-numbered data lines.

19. A display device comprising:
a plurality of pixel circuits for displaying an image;
a plurality of data lines for providing a plurality of data signals corresponding to the image to the pixel circuits; and
a demultiplexer for receiving and demultiplexing a plurality of multiplexed data signals to the data signals, and for alternately applying the data signals from each multiplexed data signal to at least two data lines,
wherein a predetermined voltage is applied to one of the at least two data lines while one of the data signals is applied to another one of the at least two data lines.

20. The display device of claim 19, wherein the demultiplexer comprises a pair of switches for applying the predetermined voltage to the one of the at least two data lines and for applying the one of the data signals to the another one of the at least two data lines, and another pair of switches for applying the predetermined voltage to the another one of the at least two data lines while applying another one of the data signals to the one of the at least two data lines.

21. The display device of claim 19, wherein the image is displayed during a frame comprising at least two fields, wherein the predetermined voltage is applied to the one of the at least two data lines while the one of the data signals is applied to the another one of the at least two data lines during one of the at least two fields, and wherein the predetermined voltage is applied to the another one of the at least two data lines while another one of the data signals is applied to the one of the at least two data lines during another one of the at least two fields.

22. The display device of claim 19, wherein the image is displayed during a frame comprising two subfields, and wherein the plurality of pixel circuits are organized as rows and columns of the pixel circuits, and wherein one of two adjacent pixels circuits in both column and row directions displays a portion of the image corresponding to one of the data signals in each of the two subfields.
